(19) United States
(12) Patent Application Publication
(10) Pub. No.: US 2013/0318540 A1
(43) Pub. Date: Nov. 28, 2013

(54) DATA FLOW GRAPH PROCESSING DEVICE, DATA FLOW GRAPH PROCESSING METHOD, AND DATA FLOW GRAPH PROCESSING PROGRAM

(71) Applicant: Takahiro Kumura, Tokyo (JP)

(72) Inventor: Takahiro Kumura, Tokyo (JP)

(73) Assignee: NEC CORPORATION, Minato-ku, Tokyo (JP)

(21) Appl. No.: 13/982,776

(22) PCT Filed: Feb. 1, 2012
(86) PCT No.: PCT/JP2012/052223

§ 371 Date: Jul. 31, 2013

(30) Foreign Application Priority Data
Feb. 1, 2011 (JP) 2011-020216

(51) Int. Cl. G06F 9/46

(52) U.S. Cl. CPC G06F 9/46
USPC 718/106

(57) ABSTRACT

A data flow graph processing device that transforms a data flow graph including a loop structure into a pipeline operation capable of determining node execution order and judging whether or not executable, comprises: a delay node divider that divides a delay node included in t data flow graph into a value update node and a value output node; a dependency relation adder that adds dependency relations from the start node of the data flow graph to the value output node; and a hidden dependency relation adder that adds hidden dependency relations, indicating previous iteration and current iteration dependencies, from the value update node to the value output node.

### TECHNICAL FIELD

The present invention relates to a data flow graph processing device, a data flow graph processing method, and a data flow graph processing program. More specifically, the present invention relates to a data flow graph processing device and the like capable transforming a data flow graph by eliminating a loop structure therefrom for making it possible to determine execution order of each node and to judge whether or not it is executable.

### BACKGROUND ART

A single personal computer normally has a single processor (CPU: Central Processing Unit, main calculation control module), and various kinds of calculation processing are executed therein. However, recently, improvement in the calculation capacity of a single processor alone has reached a limit, and the mainstream thereof is a type having a plurality of sections (cores) for actually performing the calculation processing in a single processor. The processor in such of structure is called a multicore processor.

The multicore processor can execute a plurality of threads (usage unit of processing) simultaneously by utilizing a plurality of cores. However, in order to achieve the effects for improving the operability of the multicore processor and suppressing the power consumption, it is normally required that the program side is ready for simultaneous execution of the plurality of threads. Thus, it is required to extract the parts that can be executed in parallel from a single program, and allocate those to different cores, respectively. This is called “parallelization” of computer programs.

A data flow graph is one of methods for graphically expressing a flow of data processing using a computer device. This method can be used also for the parallelization of computer program.

In a computer program parallelizing method using data flow graph, the dependency relation of each calculation is taken as a data flow graph based on data used in given calculation and the calculation result thereof. In the data flow graph, a node shows a calculation. Further, a directive edge (an arrow: referred simply to as an edge hereinafter) connecting nodes shows a data dependency relation between the nodes, i.e., shows a relation that a given calculation utilizes a result of another calculation. Further, the execution order of each of the calculations shown by each of the nodes is determined based on the data flow graph.

In a data flow graph, a series of actions in which each node executes a calculation, the calculation result is given from one node to another node connected via an edge, and the node upon receiving it executes a calculation are referred to as “pipeline” actions. The data flow graph is an illustration showing the connection of the actions of such “pipeline” calculations.

However, when a loop structure exists on a data flow graph, there is such a dependency relation that the node in the loop structure uses the calculation result of one of the nodes within the loop structure. Thus, it is impossible to determine the execution order of the nodes and to judge whether or not those are executable.

As depicted in Non-Patent Document 1, it is known that the issue of the loop structure can be overcome by using a delay node. The delay node is a node which holds an inputted value for a prescribed number of times of iterations (repetitions, reiterations) and outputs it thereafter. That is, with the delay node, the calculation result stored in a past iteration can be used in a current iteration. In a case where the data flow graph has a loop structure, the delay node is contained in the loop structure.

The delay node does not directly output an inputted value but stores it, and outputs a value stored in the past. However, there is no dependency relation between an action of “storing a current value” and an action of “outputting a value of the past”, so that it is possible to execute those actions independently from each other. Thus, in a case where such delay node exists in the loop structure, the loop structure can be broken by dividing the delay node into two nodes such as a value output node and a value update node. However, there is such a dependency relation over two or more iterations that the calculation result of a value update node in N-th iteration is used by a value output node of the (N+1)-th iteration or thereafter (N is a natural number).

FIG. 11 is an explanatory chart showing the structure of a data flow graph processing device 910 according to an existing technique depicted in Non-Patent Document 1. The data flow graph device 910 is provided with the structure as a typical computer device. That is, the data flow graph processing device 910 includes: a main calculation control module (CPU: Central Processing unit) 911 which is a main body for executing various kinds of processing written as computer programs; a storage module 912 which stores data; and an input/output module 913 which accepts data input and input operations from an operator and presents processing results to the operator.

Through operating the computer programs in the main calculation module 911, the main calculation module 911 operates as a delay node divider 912 and an execution order determination unit 924. The delay node divider 921 performs processing to be described later on a data flow graph before processing 931 stored in the storage module, and stores a data flow graph after processing 932 on which the processing is completed to the storage module 912. The execution order determination unit 924 determines the execution order of each of the nodes and judges whether or not those are executable from the data flow graph after processing 932.

FIGS. 12A-12C show explanatory charts showing the concept of the processing executed by the delay node divider 921 shown in FIG. 11. FIG. 12A is a flowchart showing an action of the delay node divider 921, FIG. 12B shows an example of the data flow graph before processing 931 inputted to the delay node divider 921, and FIG. 12C shows an example of the data flow graph after processing 932 outputted from the delay node divider 921, respectively.

In the example shown in FIG. 12B, the data flow graph before processing 931 is constituted with eight nodes A1 to A8. Among those, the nodes A7 and A8 correspond to the delay nodes. The delay node does not directly output the input data but stores it, and outputs it in a next iteration. That is, the value outputted from the delay node is a value stored by the delay node in a past iteration, and an input value in a current iteration is not used for calculating a current output value.

Thus, the delay node divider 921 divides each of the nodes A7 and A8 as the delay node into a “value output node” which outputs a value of past iteration held by the delay node and a “value update node” which stores a value of current iteration to the delay node, respectively (step S951 of FIG. 12A).

The node A7 is divided into a value update node A7u and a value output node A7o by the delay node divider 921. Similarly, the node A8 is divided into a value update node A8u and a value output node A8o by the delay node divider 921. FIG. 12C shows the result acquired by performing the delay node dividing processing on the data flow graph before processing 931 shown in FIG. 12B.

After dividing the node A7, the value update node A7u and the value output node A7o do not have a connected relation on the graph. However, the value update node A7u and the value output node A7o share the same inside state (stored data). The same for the value update node A8u and the value output node A80.

Further, an edge inputted to the delay node A7 is passed over to the value update node A7u, and an edge outputted from the delay node A7 is passed over to the value output node A7o, respectively. Similarly, an edge inputted to the delay node A8 is taken over the value update node A8u, and an edge outputted from the delay node A8 is passed over to the value output node A8o, respectively.

Non-Patent Document 1: Arquimedes Cabedo, et. al (IBM Research, Tokyo), “Automatic Parallelization of Simulink Applications”, Code Generation and Optimization 2010, Apr. 24, 2010

FIG. 13 shows explanatory charts in which the data flow graph before processing 931 and the data flow graph after processing 932 shown in FIG. 12B and FIG. 12 C are compared. In the example shown herein, in the data flow graph after processing 932, block 932a including the value output node A7o and the value update node A8u is isolated from a remaining block (block 932b) of the data flow graph after processing 932 as a result of the processing executed by the delay node divider 921.

The data flow graph before processing 931 in which all the nodes are originally connected as one is divided into two blocks such as the blocks 932a and 932b in the data flow graph after processing 932 by the processing executed by the delay node divider 921. Such state herein is referred to as “breakup of graph”.

Incidentally, whether or not such breakup of the graph occurs by dividing the delay node of the data flow graph depends on the position and the number of delay node. FIG. 14 shows charts for describing data flow graphs after processing 932 and 942 which are the results acquired by performing processing executed by the delay node divider 921, respectively, on the data flow graph before processing 931 shown in FIGS. 12 to 13 and another data flow graph before processing 941. “The data flow graph before processing 931→the data flow graph after processing 932” shows the case where breakup of the graph occurs. In the meantime, “the data flow graph before processing 941 the data flow graph after processing 942” shows the case where breakup of the graph does not occur.

In the data flow graph before processing 931, the nodes A7 and A8 as the delay nodes exist on a path on the feedback side by being connected in series. Thus, when the processing by the node divider 921 is performed thereon, breakup of the graph occurs in the data flow graph after processing 932. In the meantime, in the data flow graph before processing 941, there is only one delay node B1 existing on a path on the feedback side. When the processing by the node divider 921 is performed thereon, only the loop structure is broken in the data flow graph after processing 942. Thus, breakup of the graph does not occur.

As described above, breakup of the graph may occur when the delay node of the data flow graph is simply divided. The dependency relation in different iterations between the broken-up data flow graphs becomes unclear when breakup of the graph occurs, so that the graphs do not show pipeline actions. Therefore, it becomes impossible to determine the execution order of each calculation shown by each node of the data flow graph and to judge whether or not those can be executable. It is not possible in such case to acquire the effect of improving the operation performance of the multicore processor and suppressing the power consumption.

It is therefore an object of the present invention to provide a data flow graph processing device, a data flow graph processing method, and a data flow graph processing program, which make it possible to transform a data flow graph containing a loop structure to a data flow graph suited for pipeline actions so that it becomes possible to determine the execution order of each of the nodes and to judge whether or not those are executable.

### DISCLOSURE OF THE INVENTION

In order to achieve the foregoing object, the data flow graph processing device according to the present invention is characterized to include: a delay node divider which divides a delay node contained in an input data flow graph into a value update node and a value output node; a dependency relation adder which adds a dependency relation from a start node of the data flow graph to the value output node; and a hidden dependency relation adder which adds a hidden dependency relation showing a dependency relation from a previous iteration to a current iteration from the value update node to the value output node.

In order to achieve the foregoing object, the data flow graph processing method according to the present invention is characterized to include: dividing a delay node contained in an input data flow graph into a value update node and a value output node; adding a dependency relation from a start node of the data flow graph to the value output node; and adding a hidden dependency relation showing a dependency relation from a previous iteration to a current iteration from the value update node to the value output node.

In order to achieve the foregoing object, the data flow graph processing program according to the present invention is characterized to cause a computer to execute: a procedure for dividing a delay node contained in an input data flow graph into a value update node and a value output node; a procedure for adding a dependency relation from a start node of the data flow graph to the value output node; and a procedure for adding a hidden dependency relation showing a dependency relation from a previous iteration to a current iteration from the value update node to the value output node.

The present invention is structured to divide the delay node into the value update node and the value output node by the delay node divider as described above and then to add therebetween a hidden dependency relation showing the dependency relation between the previous iteration and the current iteration. Thus, breakup of the graph does not occur. Thereby, it is possible to provide the data flow graph processing device, the data flow graph processing method, and the data flow graph processing program, which make it possible to transform a data flow graph containing a loop structure to a data flow graph suited for pipeline actions so that it becomes possible to determine the execution order of each of the nodes and to judge whether or not to those are executable.

### BRIEF DESCRIPTION OF THE DRAWINGS

FIG. 1 is an explanatory chart showing the structure of a data flow graph processing device according to an exemplary embodiment of the present invention;

FIGS. 2A and 2B show explanatory charts regarding the concept of processing executed by a delay node divider shown in FIG. 1, in which FIG. 2A shows an example of a data flow graph before processing inputted to the delay node divider, and FIG. 2B shows an example of a first data flow graph in processing outputted from the delay node divider, respectively;

FIG. 3 shows explanatory charts in comparison with the data flow graph before processing and the first data flow graph in processing shown in FIGS. 2A and 2B;

FIGS. 4A and 4B show a flowchart regarding respective actions of the node divider, a dependency relation adder, and a hidden dependency relation adder shown in FIG. 1 and shows an explanatory chart regarding the concepts of the processing at each stage, in which: FIG. 4A is the flowchart regarding the respective actions of the node divider, the dependency relation adder, and the hidden dependency relation adder; FIG. 4B is the explanatory chart regarding the concepts of the processing at each stage; and FIG. 4A shows the change generated in a specific delay node C1 existing on the data flow graph before processing according to the processing;

FIG. 5 is an explanatory chart showing an example where processing is performed on a data flow graph before processing containing only a single delay node by the data flow graph processing device shown in FIG. 1;

FIG. 6 is a chart continued from FIG. 5;

FIG. 7 is an explanatory chart showing an example where processing is performed on a data flow graph before processing containing a plurality of delay nodes by the data flow graph processing device shown in FIG. 1;

FIG. 8 is a chart continued from FIG. 7;

FIG. 9 is a flowchart showing actions executed by an execution order determination unit shown in FIG. 1 for determining the execution order of each node and for judging whether or not those are executable;

FIGS. 10A and 10B show explanatory charts regarding the result of the execution order determined by an execution order determination unit regarding the data flow graph after processing shown in FIG. 6 and FIG. 8, in which FIG. 10A shows the data flow graph before execution order determining processing is performed and FIG. 10B shows the data flow graph after execution order determining processing is performed, respectively;

FIG. 11 is an explanatory chart showing the structure of a data flow graph processing device according to an existing technique depicted in Non-Patent Document 1;

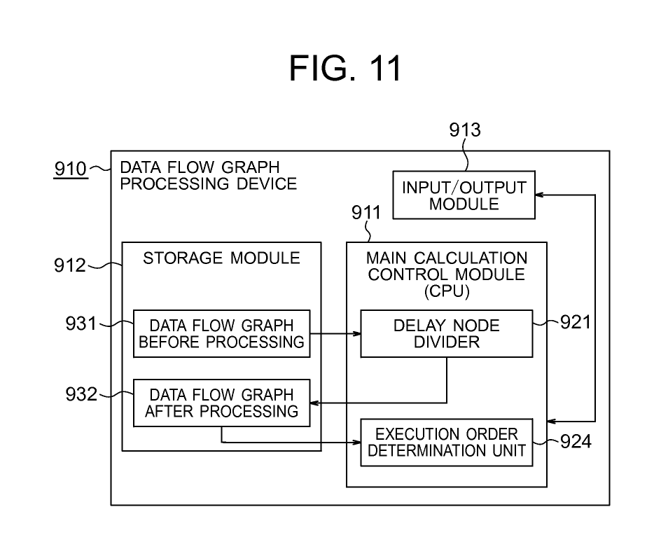

FIGS. 12A-12C show explanatory charts regarding the concept of processing executed by a delay node divider 921 shown in FIG. 11, in which FIG. 12A shows a flowchart regarding actions of the delay node divider 921, FIG. 12B shows an example of a data flow graph before processing 931 inputted to the delay node divider 921, and FIG. 12C shows an example of a data flow graph after processing 932 outputted from the delay node divider 921, respectively;

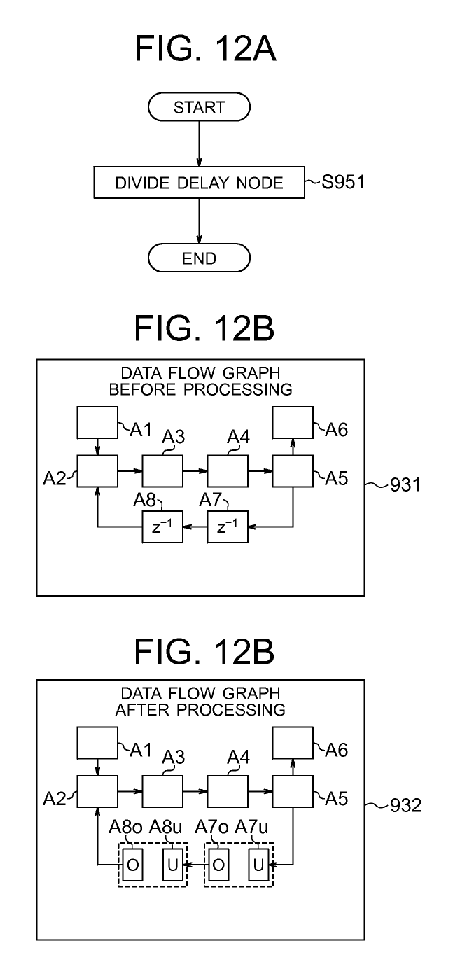

FIG. 13 shows explanatory charts of the data flow graph before processing and the data flow graph after processing shown in FIG. 12B and FIG. 12C in a comparative manner; and

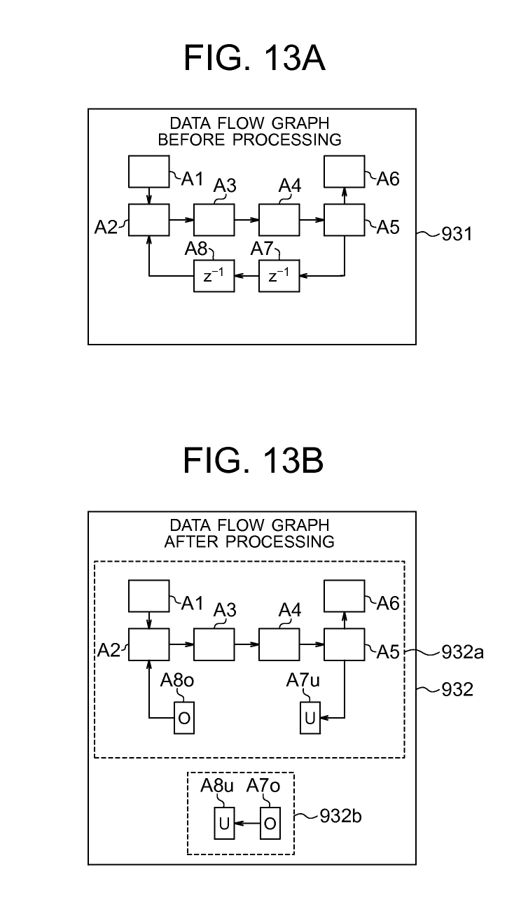

FIG. 14 shows explanatory charts regarding data flow graphs after processing acquired as a result of executing the processing by the delay node divider on the data flow graph before processing shown in FIGS. 12 to 13 and another data flow graph before processing, respectively.

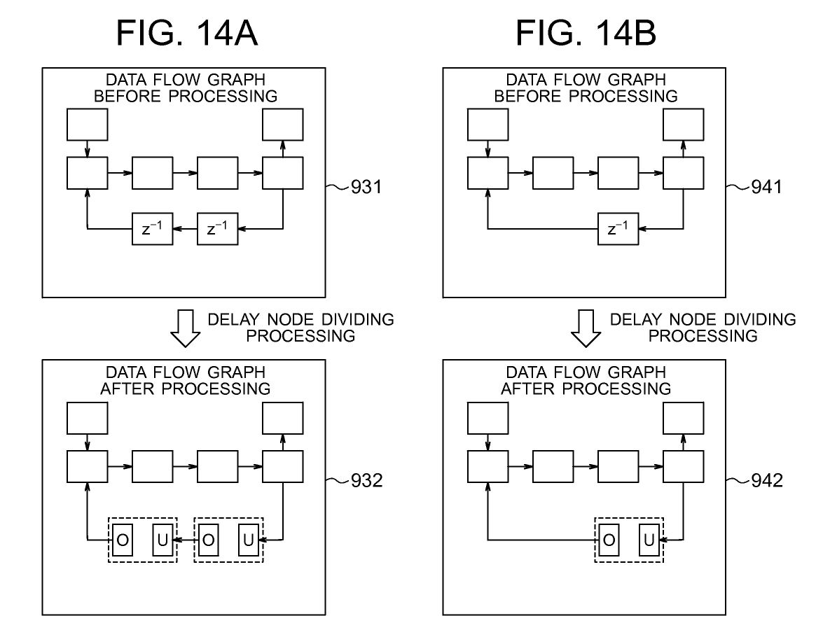

### BEST MODES FOR CARRYING OUT THE INVENTION

### First Exemplary Embodiment

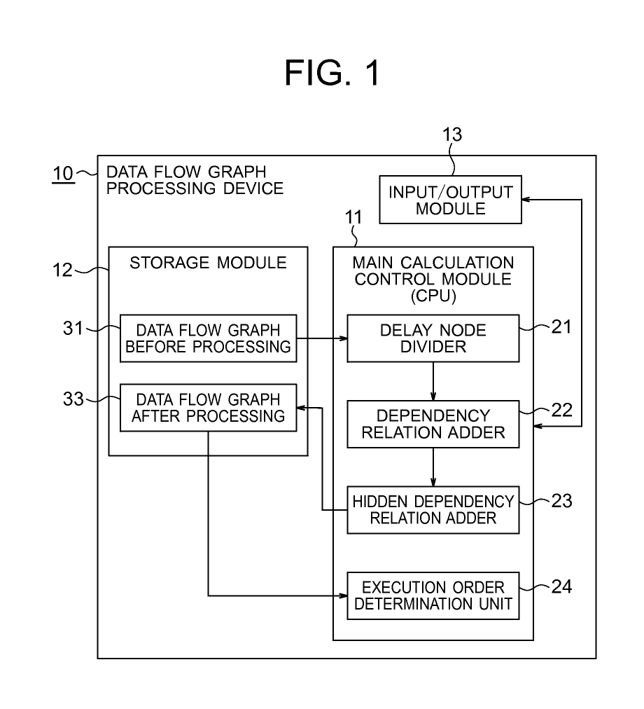

Hereinafter, the structure of a first exemplary embodiment of the present invention will be described by referring to the accompanying drawing FIG. 1.

The basic content of the exemplary embodiment will be described first, and a more specific content thereof will be described thereafter.

A data flow graph processing device 10 according to the exemplary embodiment includes: a delay node divider 21 which divides a delay node contained in an input data flow graph into a value update node and a value output node; a dependency relation adder 22 which adds a dependency relation from a start node of a data flow graph to a value output node; and a hidden dependency relation adder 23 which adds, from a value update node to the value output node, a hidden dependency relation showing a dependency relation from a previous iteration to a current iteration. Further, the data flow graph processing device 10 further includes an execution order determination unit 24 which determines the execution order by using a data flow graph to which the hidden dependency relation is added.

Further, the execution order determination unit 24 ignores the hidden dependency relation from the data flow graph to which the hidden dependency relation is added when determining the execution order of each node, and judges whether or not each node is executable based on all the dependency relations including the hidden dependency relation of the data flow graph to which the hidden dependency relation is added when judging whether or not those are executable at a certain point.

With this structure, the data flow graph processing device 10 becomes capable of transforming the data flow graph containing a loop structure to a graph with which the execution order of each node can be determined and whether or not the node is executable can be judged.

Hereinafter, this will be described in more details.

FIG. 1 is an explanatory chart showing the structure of the data flow graph processing device 10 according to the exemplary embodiment of the present invention. The data flow graph processing device 10 includes the structure as a typical computer device. That is, the data flow graph processing device 10 includes: a main calculation control module (CPU: Central processing unit) 11 which is a main body for executing various kinds of processing written as computer programs; a storage module 12 which stores data; and an input/output module 13 which accepts data input and input operations from an operator and presents processing results to the operator.

Through operating the computer programs in the main calculation module 11, the main calculation module 11 operates as each of functional units such as the delay node divider 21, the dependency relation adder 22, the hidden dependency relation adder 23, and the execution order determination unit 24. Further, those functional units perform processing to be described later on a data flow graph before processing 31 stored in the storage module, and stores a data flow graph after processing 33 on which the processing is completed to the storage module 12. Hereinafter, respective actions of the delay node divider 21, the dependency relation adder 22, and the hidden dependency relation adder 23 will be described. The action of the execution order determination unit 24 will be described later.

(Delay Node Divider)

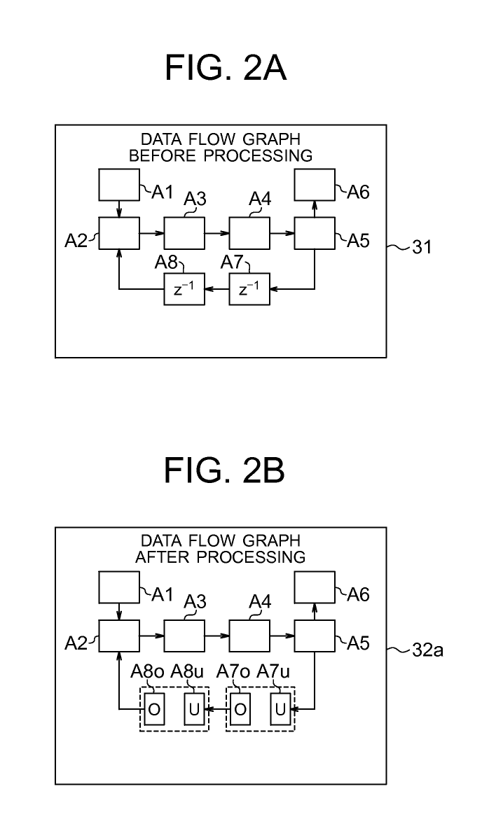

FIGS. 2A and 2B show explanatory charts regarding the concept of processing executed by the delay node divider 21 shown in FIG. 1. FIG. 2A shows an example of the data flow graph before processing 31 inputted to the delay node divider 21, and FIG. 2B shows an example of a first data flow graph in processing 32a outputted from the delay node divider 21, respectively

In the example shown in FIG. 2A, the data flow graph before processing 31 is constituted with eight nodes A1 to A8. Among those, the nodes A7 and A8 correspond to the delay nodes. The delay node does not directly output the input data but stores it, and output it in a next iteration. That is, the value outputted from the delay node is a value stored by the delay node in a past iteration, and an input value in a current iteration is not used for calculating a current output value.

Thus, the delay node divider 21 divides each of the nodes A7 and A8 as the delay node into a “value output node” which outputs a value of past iteration held by the delay node and a “value update node” which stores a value of current iteration to the delay node, respectively. The node A7 is divided into a value update node A7u and a value output node A7o by the delay node divider 21. Similarly, the node A8 is divided into a value update node A8u and a value output node A8o by the delay node divider 21. FIG. 2B shows the result acquired by performing the delay node dividing processing on the data flow graph before processing 31 shown in FIG.2A.

After dividing the node A7, the value update node A7u and the value output node A7o do not have a connected relation on the graph. However, the value update node A7u and the value output node A7o share the same inside state (stored data). This is the same for the value update node A8u and the value output node A80.

Further, an edge inputted to the delay node A7 is passed over to the value update node A7u, and an edge outputted from the delay node A7 is passed over to the value output node A7o, respectively. Similarly, an edge inputted to the delay node A8 is passed over to the value update node A8u, and an edge outputted from the delay node A8 is passed over to the value output node A8o, respectively.

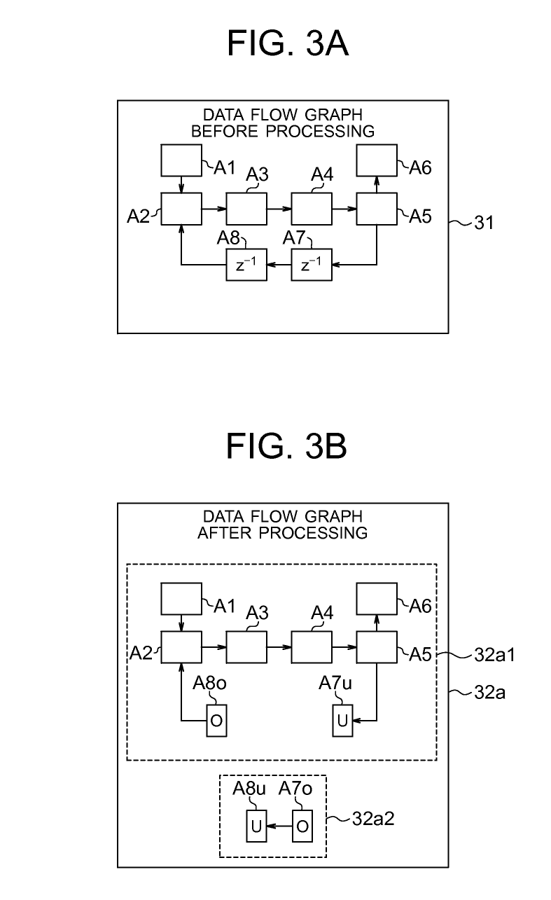

FIG. 3 shows explanatory charts in which the data flow graph before processing 31 and the first data flow graph in processing 32a shown in FIG. 2 are compared. In the example shown herein, in the first data flow graph in processing 32a, a block 32a2 containing the value output node A7o to the value update node A8u is isolated from a remaining block (block 32a1) of the first data flow graph in processing 32a as a result of the processing executed by the delay node divider 21. Such state herein is referred to as “breakup of graph”.

By the processing of the delay node divider 21 performed on the data flow graph before processing 31 in which all the nodes are originally connected as one, the first data flow graph in processing 32a is divided into two blocks such as the block 32a1 and the block 32a2. Even when such breakup of the graph occurs, there still exists a dependency relation over the graphs and iterations, i.e., the relation that the value stored by the node A7u (block 32a1) is used by the node A7o (block 32a2) in a future iteration, and the value stored by the node A8u (block 32a2) is used by the node A8o (block 32a1) in a future iteration.

The actions of the node divider 21 described above are the same as the actions of the delay node divider 921 described in the section of Related Art. As described herein, breakup of the graph may occur when only the delay node of the data flow graph is divided. When breakup of the graph occurs, the dependency relation between the broken-up data flow graphs becomes unclear. Thus, it becomes difficult to repeatedly operate each node of the data flow graph in a pipeline manner.

(Dependency Relation Adder and Hidden Dependency Relation Adder)

In order to overcome such issue and to make it easy to repeatedly operate each node of the data flow graph in a pipeline manner, the exemplary embodiment includes the dependency relation adder 22 and the hidden dependency relation adder 23 shown in FIG. 1 in addition to the node divider 21.

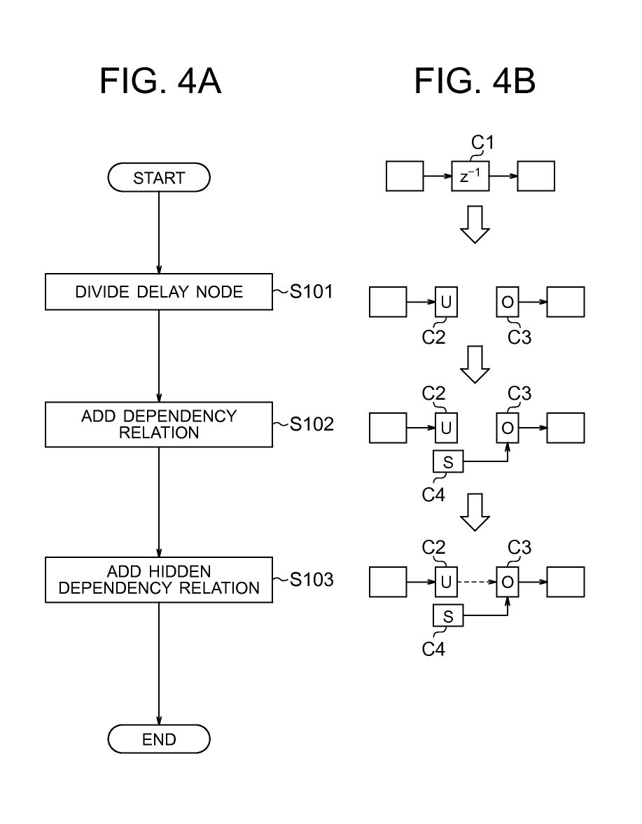

FIGS. 4A and 4B show a flowchart regarding respective actions of the node divider 21, the dependency relation adder 22, and the hidden dependency relation adder 23 shown in FIG. 1 and shows an explanatory chart regarding the concepts of the processing at each stage. FIG. 4A shows the flowchart regarding the respective actions of the node divider 21, the dependency relation adder 22, and the hidden dependency relation adder 23, and FIG. 4B shows the explanatory chart regarding the concepts of the processing at each stage. FIG. 4A shows the change generated in a specific delay node C1 existing on the data flow graph before processing 31 according to the processing.

As described in FIG. 2 to FIG. 3, the node divider 21 to which the data flow graph before processing 31 is inputted performs an action for dividing the delay node C1 into a value update node C2 and a value output node C3, and outputs the first data flow graph in processing 32a (step S101).

Subsequently, the dependency relation adder 22 performs processing for adding the dependency relation (edge) from a start node C4 to the value output node C3 to the first data flow graph in processing 32a, and outputs a second data flow graph in processing 32b (step S102).

Note here that the start node C4 is the node that is the start point of the processing for all the nodes in a processing-target data flow graph. The dependency relation adder 22 adds the edge from the start node C4 to the value output node C3 to prevent the value output node C3 from being isolated form the original data flow graph and to show that the value output node C3 can be executed immediately after the start node C4.

At last, the hidden dependency relation adder 23 performs the processing for adding the hidden dependency relation (dashed-line edge) from the value update node C2 to the value output node C3 on the second data flow graph in processing 32b, and outputs the data flow graph after processing 33 (step S103). The hidden dependency relation herein means a mutual dependency relation from the N-th iteration to the (N+1)-th iteration.

The execution determination unit 24 does not consider the dashed-line edge of the hidden dependency relation as a normal edge, and considers that there is no dependency relation from the value update node C2 to the value output node C3 in the same iteration. At the same time, the data flow graph processing device 10 ignores the hidden dependency relation when determining the execution order of each node in a single iteration on the data flow graph. Further, the execution order determination unit 24 uses all the dependency relations including the hidden dependency relation, when judging whether or not the node is executable. Details thereof will be described later.

(Processing Example of Data Flow Graph Containing Only One Delay Node)

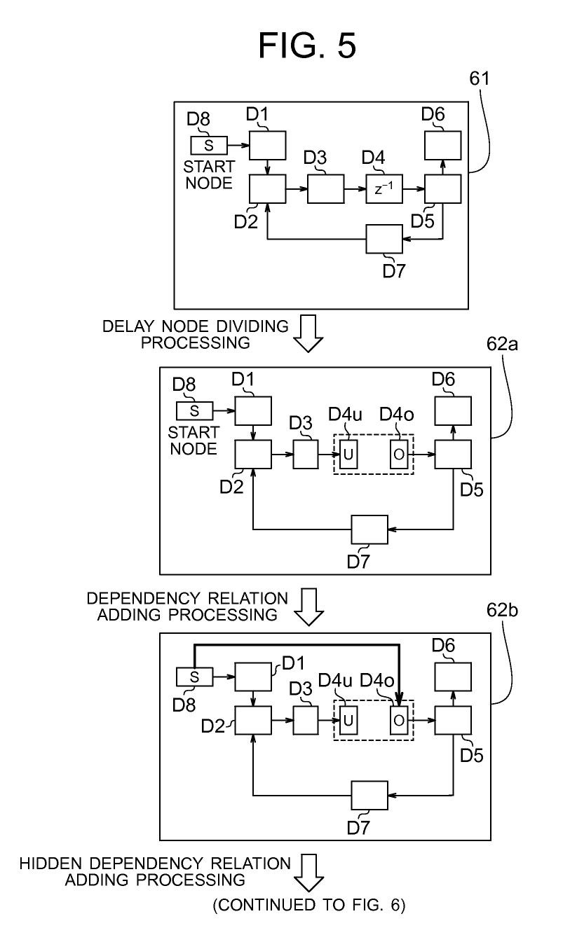

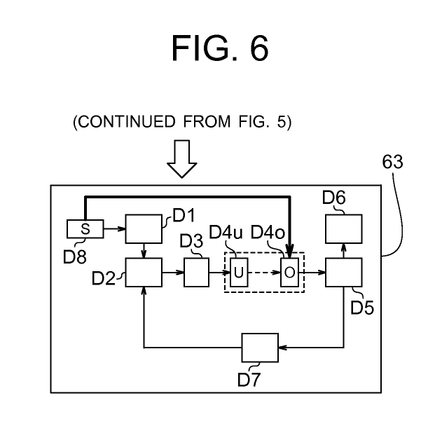

Hereinafter, contents of the processing actually executed by the data flow graph processing device 10 will be described by referring to an actual example. FIGS. 5 to 6 are explanatory charts (shown separately over two pages because of the size of the paper) showing an example of performing processing on a data flow graph before processing 61 containing only a single delay node by the data flow graph processing device 10 shown in FIG. 1. The data flow graph 61 is constituted with eight nodes D1 to D8, and there is a loop structure therein constituted with the nodes D2 to D5 and D7. Further, the node D4 is the delay node.

The node divider 21 to which the data flow graph before processing 61 is inputted divides the node D4 as the delay node into a value update node D4u and a value output node D4o, an input edge to the delay node D4 is passed over to the value update node D4u, and an output edge from the delay node D4 is passed over to the value output node D4o, respectively (FIG. 4: step S101). The processing result is a first data flow graph in processing 62a shown in FIG. 5.

Subsequently, the dependency relation adder 22 adds the dependency relation (edge) from a start node D8 to the value output node D4o to the first data flow graph in processing 62a (step S102). This processing result is a second data flow graph in processing 62b shown in FIG. 5.

At last, the hidden dependency relation adder 23 adds the hidden dependency relation (dashed-line edge) from the value update node D4u to the value output node D4o to a second data flow graph in processing 62b (step S103). This processing result is a data flow graph after processing 63 shown in FIG. 6.

In case that the hidden dependency relation is ignored, it is found that there is no loop structure in the data flow graph after processing 63. The execution order determination unit 24 ignores the hidden dependency relation (dashed-line edge) and uses only the normal dependency relation, when determining the execution order of each of the nodes. Further, the execution order determination unit 24 uses all the dependency relations including the hidden dependency relation (dashed-line edge) in order to judge whether or not execution of each node can be started. Determination of the execution order of each node and judgment regarding whether or not execution of each node can be started will be described later.

(Processing Example of Data Flow Graph Containing Plurality of Delay Nodes)

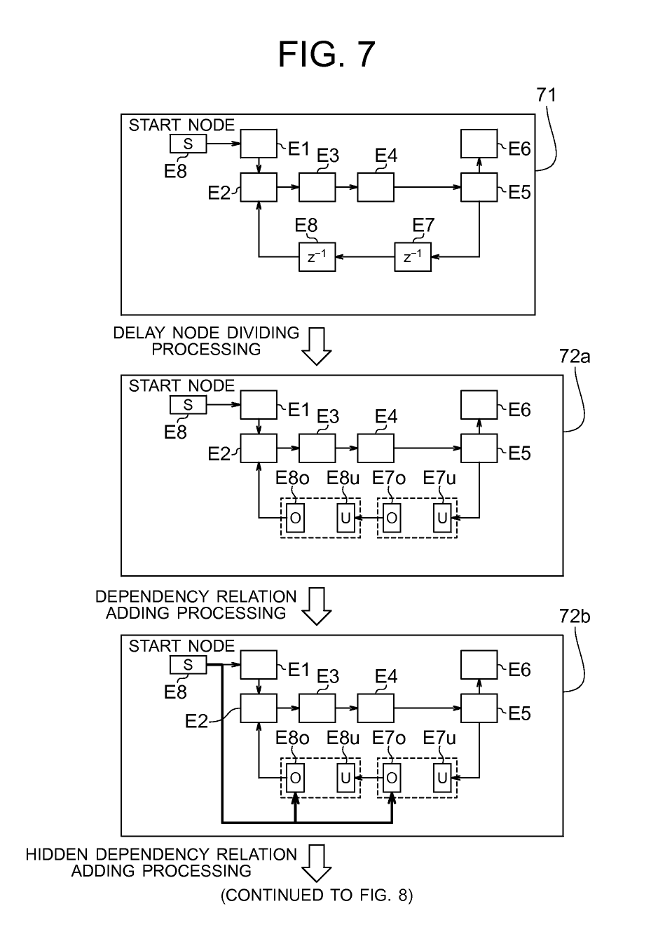

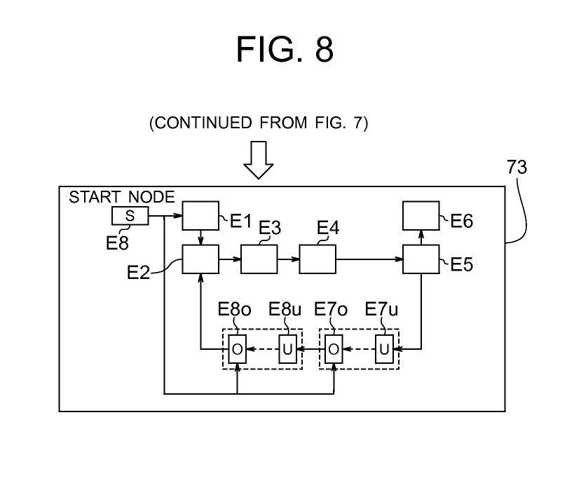

FIGS. 7 to 8 are explanatory charts (shown separately over two pages because of the size of the paper) showing an example of performing processing on a data flow graph before processing 71 containing a plurality of delay nodes by the data flow graph processing device 10 shown in FIG. 1. The data flow graph 71 is constituted with nine nodes E1 to E9, and there is a loop structure therein constituted with the nodes E2 to E5 and E7 to E8. Further, the nodes E7 and E8 are the delay nodes.

The node divider 21 to which the data flow graph before processing 71 is inputted divides the nodes E7 and E8 as the delay nodes into a value update node E7u and a value output node E7o and into a value update node E8u and a value output node E8o, respectively. An input edge to the delay node E7 is passed over to the value update node E7u, and an output edge from the delay node E7 is passed over to the value output node E7o, respectively. Further, an input edge to the delay node E8 is passed over to the value update node E8u, and an output edge from the delay node E8 is passed over to the value output node E8o, respectively (FIG. 4: step S101). The processing result is a first data flow graph in processing 72a shown in FIG. 8.

Subsequently, the dependency relation adder 22 adds the dependency relation (edge) from the start node E9 to the value output nodes E7o, E8o to the first data flow graph in processing 72a (step S102). This processing result is a second data flow graph in processing 72b shown in FIG. 8.

At last, the hidden dependency relation adder 23 adds the respective hidden dependency relations (dashed-line edges) from the value update node E7u to the value output node E7o and from the value update node E8u to the value output node E8o to the second data flow graph in processing 72b (step S103). This processing result is a data flow graph after processing 73 shown in FIG. 8.

In case that the hidden dependency relation is ignored, it is found that there is no loop structure in the data flow graph after processing 73. The execution order determination unit 24 ignores the hidden dependency relation (dashed-line edge) and uses only the normal dependency relation, when determining the execution order of each node. Further, the execution order determination unit 24 uses all the dependency relations including the hidden dependency relation (dashed-line edge) in order to judge whether or not execution of each node can be started. Determination of the execution order of the each of the nodes and judgment regarding whether or not execution of each node can be started will be described later.

(Determination of Execution Order and Judgment regarding Execution)

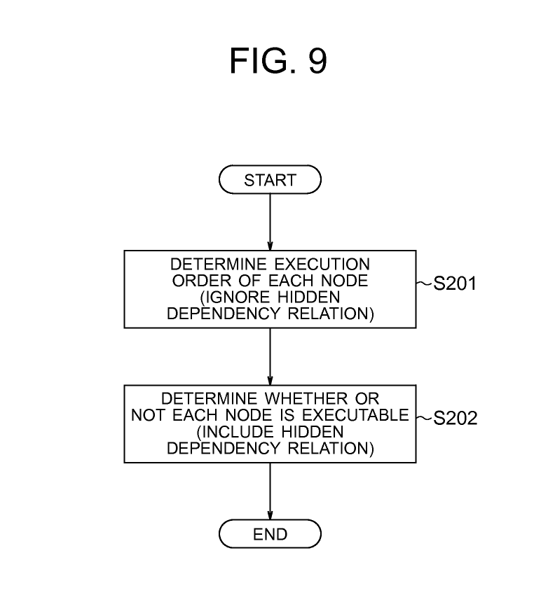

FIG. 9 is a flowchart showing actions executed by the execution order determination unit 24 shown in FIG. 1 for determining the execution order of each of the nodes and for judging whether or not those are executable. The execution order determination unit 24 determines the execution order of each node on the data flow graph after processing 33 outputted from the hidden dependency relation adder 23 (step S201), and judges whether or not execution of each node can be started (step S202).

When the execution order determination unit 24 determines the execution order of each of the nodes in step S201, the hidden dependency relation (dashed-line edge) on the data flow graph after processing 33 is ignored if there is any, and executes a width-first search or a depth-first search by having the start node as the start point to allocate different numbers to each of the nodes. The numbers allocated in this manner show the execution order of the nodes. As described above, no loop structure exists on the data flow graph after processing 33 in case that the hidden dependency relation (dashed-line edge) is ignored, so that such processing can be executed easily.

When the execution order determination unit 24 judges whether or not execution of each node can be started in step S202, a given node is considered to be executable in a case where the processing on all the input edges including the hidden dependency relation (dashed-line edge) connected to the given node is completed regarding all the nodes on the data flow graph after processing 33. Incidentally, the fact that execution of each of the nodes is completed is transmitted from the node to the node having the dependency relation therewith as a signal. Further, the start node does not have an input edge, so that it can be executed at all times as long as there is an execution start command received from a user.

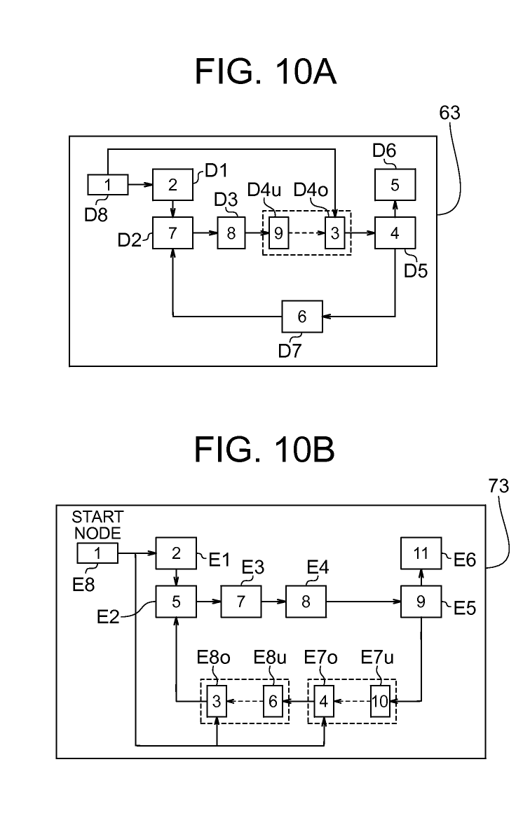

FIGS. 10A-10B show explanatory charts showing the results of the execution orders determined by the execution order determination unit 24 regarding the data flow graphs after processing 63 and 73 shown in FIG. 6 and FIG. 8. FIG. 10A shows the determined execution order of the data flow graph before processing 63, and FIG. 10B shows the determined execution order of the data flow graph after processing 73, respectively. The execution order is shown with the number applied to each node.

Regarding the data flow graph after processing 63, the start node D8 is first set as the execution order “1”. From the start node D8, solid-line edges showing the dependency relation are connected to the nodes D1 and D4o. Thus, the node D1 is set as the execution order “2” and the node D4o is set as the execution order “3” so that the orders thereof do not overlap with each other between the nodes. Naturally, the execution orders of the nodes D1 and D4o may be inverted.

A solid-line edge showing the dependency relation is connected from the node D1 to the node D2. However, in addition to that, there is also an input edge from the node D7 to the node D2, so that the node D2 is not yet executed at this point. Thus, only the node D5 to which a solid-line from the node D4o is connected is executed, and the execution order thereof becomes “4”.

Solid-line edges showing the dependency relation are connected from the nodes D6 and D7 to the node D5. Thus, as described earlier, the nodes D6 and D7 are set as execution orders “5” and “6”, respectively, so that the orders thereof do not overlap with each other between the nodes. At this point, the above-mentioned node D2 becomes executable because the processing of the input edge from the node D7 is completed. The execution order thereof is “7”.

Thereafter, the node D3 is set as the execution order “8” and the node D4u is set as the execution order “9” in the same manner. All the nodes of the data flow graph after processing 63 are executed up to this point, and it can be found that there is no node that cannot be executed.

Similarly, regarding the data flow graph after processing 73, the start node E8 is first set as the execution order “1”. From the start node E8, solid-line edges showing the dependency relation are connected to the nodes E1, E8o, and E7o. Thus, those are set as the execution orders “2”, “3”, and “4”, respectively.

Solid-line edges showing the dependency relation are connected from the nodes E1 and E8o to the node E2. Similarly, a solid-line edge showing the dependency relation is connected from the node E7o to the node E8u. Thus, the node E2 and the node E8u are set as the execution orders “5” and “6”, respectively. Note that the processing of the input edges from the nodes E1 and E8o connected to the node E2 is completed until the execution order of “3”, so that the node E2 can be executed at this point.

Thereafter, the node E3 is set as the execution order “7”, the node E4 is set as the execution order “8”, the node E5 is set as the execution order “9”, the node E7u is set as the execution order “10”, and the node E6 is set as the execution order “11” in the same manner. All the nodes of the data flow graph after processing 73 are executed up to this point, and it can be seen that there is no node that cannot be executed.

### Overall Actions of First Exemplary Embodiment

Next, the overall actions of the exemplary embodiment will be described. A data flow graph processing method according to the exemplary embodiment is designed to: divide the delay node contained in the input data flow graph into a value update node and a value output node (FIG. 4: step S101); add the dependency relation from the start node of the data flow graph to the value output node (FIG. 4: step S102); and add the hidden dependency relation showing the dependency relation from a previous iteration to a current iteration from the value update node to the value output node (FIG. 4: step S103). Then, the execution order is determined by using the data flow graph to which the hidden dependency relation is added (FIG. 9: steps S201 to 202).

Further, in the processing executed by the execution order determination unit for determining the execution order and judging whether or not to be executable: the hidden dependency relation is ignored from the data flow graph to which the hidden dependency relation is added, when determining the execution order of each of the nodes (FIG. 9: step S201); and whether or not each node is executable is judged based on all the dependency relations including the hidden dependency relation of the data flow graph to which the hidden dependency relation is added, when judging whether or not each node of the data flow graph is executable at a certain point (FIG. 9: step S202).

Note here that each of the above-described steps may be put into programs to be executed by a computer, and each of the steps may be executed by the personal computer 10. The program may be recorded on a non-transitory recording medium such as a DVD, a CD, a flash memory, or the like. In that case, the program is read out from the recording medium and executed by the computer.

Through this operation, the exemplary embodiment can provide following effects.

In the exemplary embodiment, the solid-line edge showing the dependency relation is added from the start node by using the fact that the value output node can be executed immediately after the start node when the delay node is divided into the value output node and the value update node. Further, the relation between the divided value output node and the value update node is expressed as the “hidden dependency relation” which shows the dependency relation between the iterations.

Therefore, breakup of the graph caused by dividing the delay node as described in the section of the Related Art does not occur herein. Further, the execution order can be determined based only on the dependency relation by ignoring the hidden dependency relation. Also, judgment regarding whether or not to be executable can be done by utilizing all the dependency relations including the hidden dependency relation.

In this Description, the example of the case of executing processing on the data flow graph having one or two delay nodes by the device or the method of the exemplary embodiment is presented. However, it is possible with the exemplary embodiment to execute the processing on the data flow graph containing an arbitrary number of delay nodes. Further, with the exemplary embodiment, no specific limit is set in the number of delay nodes and the positions thereof.

While the present invention has been described above by referring to the specific embodiment shown in the drawings, the present invention is not limited only to the embodiment described above. Any other known structures can be employed, as long as the embodiments of the present invention can be achieved therewith.

Regarding each of the embodiments described above, the new technical contents of the above-described embodiments can be summarized as follows. While a part of or a whole part of the embodiments can be summarized as follows as the new techniques, the present invention is not necessarily limited only to the followings.

(Supplementary Note 1)

A data flow graph processing device which includes:
a delay node divider which divides a delay node contained in an input data flow graph into a value update node and a value output node;
a dependency relation adder which adds a dependency relation from a start node of the data flow graph to the value output node; and
a hidden dependency relation adder which adds a hidden dependency relation showing a dependency relation from a previous iteration to a current iteration from the value update node to the value output node.

(Supplementary Note 2)

The data flow graph processing device as depicted in Supplementary Note 1, which includes
an execution order determination unit which determines the execution order by using the data flow graph to which the hidden dependency relation is added.

(Supplementary Note 3)

The data flow graph processing device as depicted in Supplementary Note 1, wherein the execution order determination unit:
determines the execution order of each node while ignoring the hidden dependency relation from the data flow graph to which the hidden dependency relation is added; and judges whether or not each node is executable based on all the dependency relations including the hidden dependency relation of the data flow graph to which the hidden dependency relation is added, when judging whether or not each node is executable at a certain point.

(Supplementary Note 4)

A data flow graph processing method which includes:
dividing a delay node contained in an input data flow graph into a value update node and a value output node;
adding a dependency relation from a start node of the data flow graph to the value output node; and
adding a hidden dependency relation showing a dependency relation from a previous iteration to a current iteration from the value update node to the value output node.

(Supplementary Note 5)

The data flow graph processing method as depicted in Supplementary Note 4, which includes
determining the execution order by using the data flow graph to which the hidden dependency relation is added.

(Supplementary Note 6)

The data flow graph processing method as depicted in Supplementary Note 5, wherein, in the execution order determining processing:
the hidden dependency relation is ignored from the data flow graph to which the hidden dependency relation is added, when determining the execution order of each node; and
whether or not each node is executable is judged based on all the dependency relations including the hidden dependency relation of the data flow graph to which the hidden dependency relation is added, when judging whether or not each node of the data flow graph is executable at a certain point.

(Supplementary Note 7)

A data flow graph processing program which causes a computer to execute:
a procedure for dividing a delay node contained in an input data flow graph into a value update node and a value output node;
a procedure for adding a dependency relation from a start node of the data flow graph to the value output node; and
a procedure for adding, from the value update node to the value output node, a hidden dependency relation showing a dependency relation from a previous iteration to a current iteration from the value update node to the value output node.

(Supplementary Note 8)

The data flow graph processing program as depicted in Supplementary Note 7, which causes the computer to execute a procedure for determining the execution order by using the data flow graph to which the hidden dependency relation is added.

(Supplementary Note 9)

The data flow graph processing program as depicted in Supplementary Note 8, wherein, in the procedure for determining the execution order and judging whether or not executable:
determines the execution order of each node while ignoring the hidden dependency relation from the data flow graph to which the hidden dependency relation is added; and
dudges or not each node is executable is judged based on all the dependency relations including the hidden dependency relation of the data flow graph to which the hidden dependency relation is added, when judging whether or not each node of the data flow graph is executable at a certain point.

This Application claims the Priority right based on Japanese Patent Application No. 2011-020216 filed on Feb. 1, 2011 and the disclosure thereof is hereby incorporated by reference in its entirety.

### INDUSTRIAL APPLICABILITY

The present invention can be employed for parallelization of computer programs and for making the computer programs compatible to multicore processors (or multithread processors, or the like).

### REFERENCE NUMERALS

10 Data flow graph processing device
11 Main calculation control module
12 Storage module
13 Input/output module
21 Delay node divider
22 Dependency relation adder
23 Hidden dependency relation adder
24 Execution order determination unit
31, 61, 71 Data flow graph before processing
32a, 32b, 62a, 62b, 72a, 72b Data flow graph in processing
32a1, 32a2 Block
33, 63, 73 Data flow graph after processing

What is claimed is:

1. A data flow graph processing device, comprising:
a delay node divider which divides a delay node contained in an input data flow graph into a value update node and a value output node;
a dependency relation adder which adds a dependency relation from a start node of the data flow graph to the value output node; and
a hidden dependency relation adder which adds a hidden dependency relation showing a dependency relation from an n-th execution of a calculation corresponding to the data flow graph to an (n+1)-th execution of the calculation from the value update node to the value output node.

2. The data flow graph processing device as claimed in claim 1, comprising
an execution order determination unit which determines an execution order by using the data flow graph to which the hidden dependency relation is added.

3. The data flow graph processing device as claimed in claim 2, wherein the execution order determination unit:
determines the execution order of each node while ignoring the hidden dependency relation from the data flow graph to which the hidden dependency relation is added, when determining the execution order of each node; and
judges whether or not each node is executable based on all the dependency relations including the hidden dependency relation of the data flow graph to which the hidden dependency relation is added, when judging whether or not each node is executable at a certain point.

4. A data flow graph processing method, comprising:
dividing a delay node contained in an input data flow graph into a value update node and a value output node;
adding a dependency relation from a start node of the data flow graph to the value output node; and
adding a hidden dependency relation showing a dependency relation from an n-th execution of a calculation corresponding to the data flow graph to an (n+1)-th execution of the calculation from the value update node to the value output node.

5. The data flow graph processing method as claimed in claim 4, comprising
determining an execution order by using the data flow graph to which the hidden dependency relation is added.

6. The data flow graph processing method as claimed in claim 5, wherein, in the execution order determining processing:
determines the execution order of each node while ignoring the hidden dependency relation from the data flow graph to which the hidden dependency relation is added; and
judges or not each node is executable is judged based on all the dependency relations including the hidden dependency relation of the data flow graph to which the hidden dependency relation is added, when judging whether or not each node of the data flow graph is executable at a certain point.

7. A non-transitory computer readable recording medium storing a data flow graph processing program which causes a computer to execute:
a procedure for dividing a delay node contained in an input data flow graph into a value update node and a value output node;
a procedure for adding a dependency relation from a start node of the data flow graph to the value output node; and
a procedure for adding, from the value update node to the value output node, a hidden dependency relation showing a dependency relation from an n-th execution of a calculation corresponding to the data flow graph to an (n+1)-th execution of the calculation from the value update node to the value output node.

8. A data flow graph processing device, comprising:
delay node dividing means for dividing a delay node contained in an input data flow graph into a value update node and a value output node;
dependency relation adding means for adding a dependency relation from a start node of the data flow graph to the value output node; and
hidden dependency relation adding means for adding a hidden dependency relation showing a dependency relation from an n-th execution of a calculation corresponding to the data flow graph to an (n+1)-th execution of the calculation from the value update node to the value output node.
